(19) United States
(12) Patent Application Publication
(10) Pub. No.: US 2016/0300212 A1
(43) Pub. Date: Oct. 13, 2016

(54) SYSTEMS AND METHODS FOR DETECTING RETAIL ITEMS STORED IN THE BOTTOM OF THE BASKET (BOB)

(71) Applicant: HEB Grocery Company LP, San Antonio, TX (US)

(72) Inventors: Rolando H. Cordova, San Antonio, TX (US); Felipe Daniel Gonzalez, San Antonio, TX (US)

(21) Appl. No.: 14/681,918

(22) Filed: Apr. 8, 2015

(51) Int. Cl. G06Q 20/20; G07G 1/01; H04N 7/18; G07G 1/00

(52) U.S. Cl. CPC G06Q 20/208; G07G 1/0036; G07G 1/01; H04N 7/183

(57) ABSTRACT

Systems and methods are described for detecting items located in the bottom of a customer's shopping cart basket. Such items are often hidden from the immediate view of cashiers and other store employees, and therefore, may not be properly accounted for during checkout. Therefore, a relatively inexpensive solution for detecting and displaying the bottom of basket area to cashiers and/or other store employees is desired so that losses associated with such items can be minimized.

### BACKGROUND

The present disclosure generally relates to systems and methods for detecting and viewing items stored in the bottom of a customer's basket or shopping cart, which location ordinarily may not be visible to a cashier or other store employee processing checkout.

A common configuration for shopping carts, especially in the grocery store context, is to have both an upper basket, in which the customer can load most purchases, and a lower basket, in which the customer might load heavier or bulkier items. One advantage of such configuration is that customers can access the majority of their items without interference from the heavier and/or bulkier items stored in the bottom of the basket (BOB).

Because of the nature of items typically stored in BOB, it may be difficult or impossible to load such items onto a standard checkout lane. For example, such items might be too large to fit on the lane, or simply too heavy for certain customers and/or cashiers to lift and manipulate in the ways necessary to effectuate checkout. Additionally, typical checkout lane configurations often do not allow a cashier to easily assess whether items are stored in BOB. Therefore, cashiers may be forced to rely on customers to inform them that additional items are stored in BOB and need to be accounted for in such situations. Because items stored in BOB often are not in the line of sight of customers, however, customers sometimes forget about such items during checkout. Other customers may purposefully store items in BOB with the hope or expectation that they might avoid payment for those items. Thus, for a variety of reasons, customers might fail to inform the cashier that there are items stored in BOB.

Whether a customer fails to alert a cashier to items stored in BOB purposefully or otherwise, such failures can cost retailers significant amounts of money. If the cashier does not independently notice such items, the customer may leave the store without paying for the items. Therefore, it is desirable to provide systems and methods to assist a cashier or other store employee in determining whether or not there are items stored in BOB.

Various solutions have been proposed to alert employees to items in BOB, but existing solutions generally are so technically complex or cost-prohibitive as to render them unworkable for many retail establishments.

### SUMMARY

The present disclosure generally relates to systems and methods for detecting items in BOB, and more particularly, to systems and methods for providing an image of BOB to a cashier conducting retail checkout.

In one embodiment, the present disclosure provides a relatively inexpensive BOB detection system capable of displaying images of BOB to a cashier or other store employee responsible for verifying whether items are stored in BOB. This solution can optionally be implemented and contained as a single unit for ease of installation or retrofitting equipment.

In another embodiment, the present disclosure provides that the cashier or other store employee responsible for verifying whether items are stored in BOB can optionally add items to a customer's order without physically scanning or otherwise manipulating the items. Further embodiments and combinations of embodiments are described and would be apparent to those skilled in the art throughout the present disclosure.

The features and advantages of the present disclosure will be apparent to those skilled in the art. While numerous changes may be made by those skilled in the art, such changes are within the spirit of the invention and disclosure.

### BRIEF DESCRIPTION OF THE FIGURES

Some specific example embodiments of the disclosure may be understood by referring, in part, to the following description and the accompanying figures.

FIG. 1 is a representation of a standard shopping cart and checkout lane that may be used in accordance with certain embodiments of the present disclosure.

FIGS. 2 and 3 are representations that depict a detection and image collection unit according to certain embodiments of the present disclosure.

FIG. 4 is a representation of an exemplar screen capture of a cashier terminal screen that depicts an image of BOB as it might be presented to a store employee according to certain embodiments of the present disclosure.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION OF EMBODIMENTS

The present disclosure generally relates to systems and methods for detecting items in BOB.

More particularly, the present disclosure provides systems and methods for providing an image of the BOB area (and optionally, other information) to a cashier conducting retail checkout. In the methods of the present disclosure, a shopping cart with a reflective surface (e.g., by nature of the material used, a sticker affixed to the cart, special paint, or some other means) passes a BOB detection unit installed in a checkout lane. In doing so, the reflective portion of the cart passes a reflective photo beam sensor. The sensor is coupled with an image collection device, such as a digital camera unit, in such a way that triggering the reflective photo beam sensor causes the image collection device to capture an image of BOB. The image is then passed to the cashier processing checkout for further consideration. The present disclosure also provides methods by which a cashier must acknowledge the presence or absence of items in BOB before continuing checkout. The present disclosure also provides systems that are configured in a variety of ways so as to provide images of BOB in a simple, cost-effective manner.

In many embodiments, retailers using or providing the methods and systems of the present disclosure may be retrofitting existing equipment in order to provide the desired functionality. As described herein, the present disclosure describes the ability to package the invention in a self-contained, easily installed unit that is compatible with most existing checkout systems and configurations. Additionally, any cart can be made to work with the present invention by affixing or providing a reflective surface on a portion of the cart that passes the reflective photo beam sensor. The reflective photo beam sensor may be any suitable unit capable of both projecting and receiving a photoelectric beam capable of transmission to and from a reflective surface. Additionally, a person of skill in the art would understand that, if desired, separate sensors could be used for emitting and receiving the signal. Similarly, the image collection device can be any device capable of capturing an image that can then be displayed to a cashier. Although a USB camera is described below in connection with the preferred embodiment, a person of skill in the art would understand that a variety of other solutions could be utilized as well. The reflective photo beam sensor and image collection device are configured such that when the photo sensor is triggered, an image taken with the image collection device will show whether any items are stored in BOB. That image can be displayed to the cashier or other store employee responsible for that checkout lane, and the employee can be made to acknowledge whether or not items are present in BOB before proceeding with checkout.

Among the many potential advantages to the methods and compositions of the present disclosure, only some of which are alluded to herein, the methods and systems of the present disclosure may provide a more efficient, cost-effective, and/or flexible means of detecting items stored in BOB. In some embodiments, the methods and systems of the present disclosure may provide retailers greater variety and/or choice in methods of designing or retrofitting checkout lanes and terminals in ways that minimize losses for the retailers.

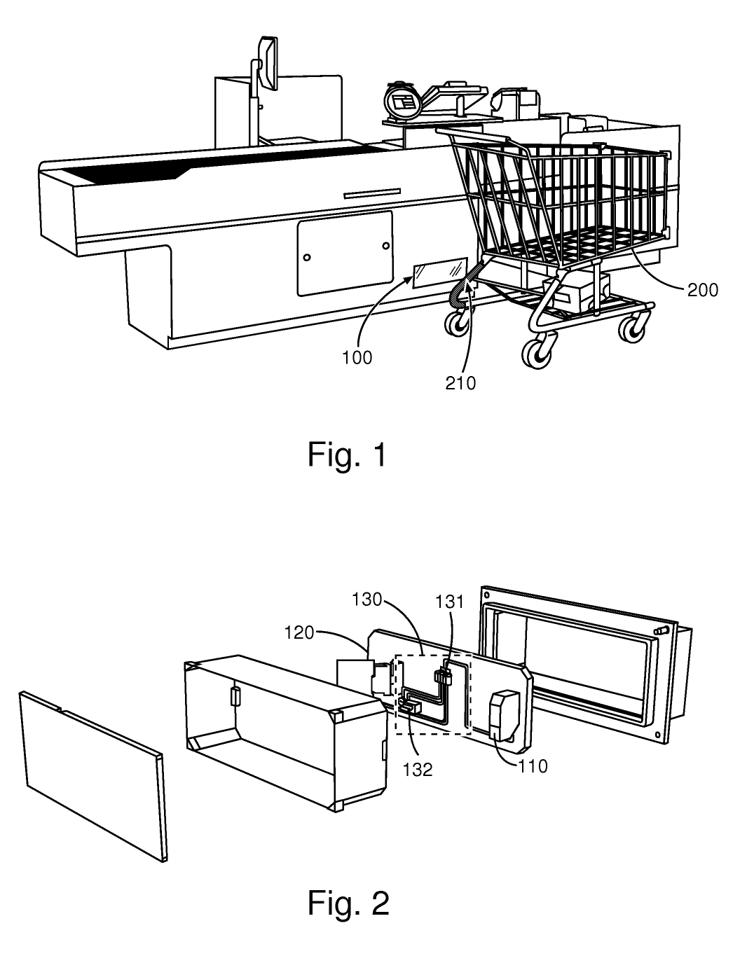

FIG. 1 illustrates an example BOB detection system 100 for detecting the presence of items stored in BOB in a standard checkout lane according to certain embodiments of the present disclosure. The system works with any standard shopping cart 200 that has a reflective surface 210. The reflective surface can be any surface capable of reflecting a photoelectric signal, and for example, could be provided by the use of special material, paint, or a sticker affixed to that portion of the shopping cart that passes in front of the system 100.

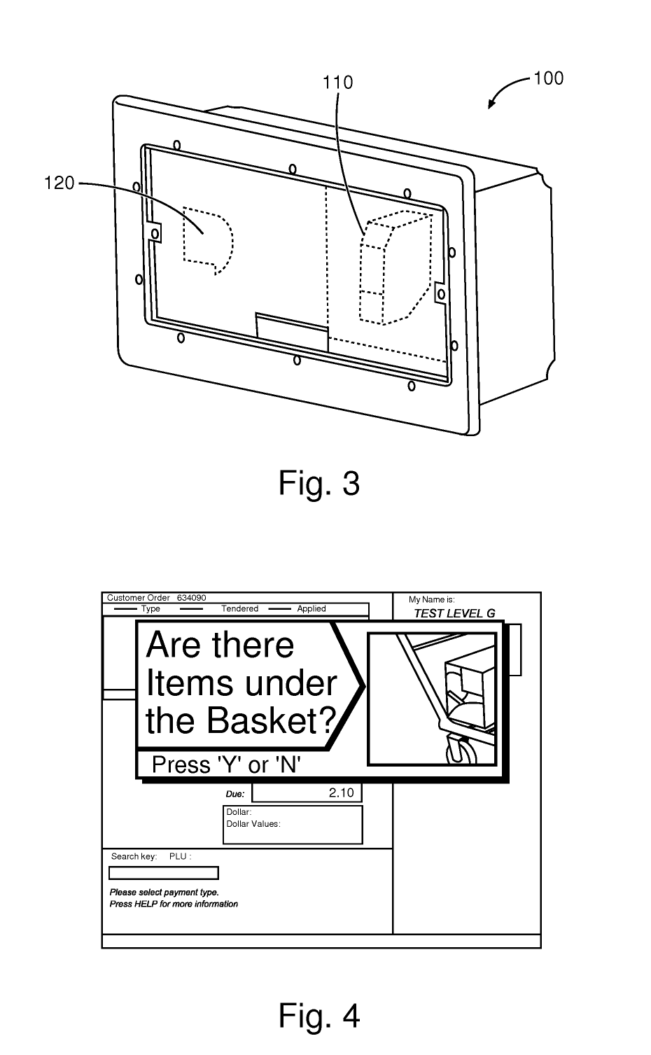

FIGS. 2 and 3 illustrate more detailed views of certain components of a preferred embodiment of the BOB detection system 100. For example, system 100 includes at least a reflective photo beam sensor 110, an image collection device 120, and a control circuit 130. Sensor 110 emits a photoelectric signal in the area in front of BOB detection system 100. When a reflective surface, such as the surface 210 of a shopping cart, passes in front of the system 100, the photoelectric signal is reflected back to the BOB detection system 100 and is detected by the receiver portion of the reflective photo beam sensor 110. Importantly, non-reflective surfaces in the area in front of the BOB detection system 100, such as children or customers without shopping carts, will have no effect on sensor 110. Additionally, a person of skill in the art will recognize that the reflective photo beam sensor 110 can be realized with any conventional sensor that is capable of both emitting and receiving photoelectric reflective signals, as well as by combining separate emitting and receiving sensors.

The control circuit 130 is configured such that when the reflective photo beam sensor 110 is triggered by the detection of a reflective surface in the area in front of the BOB detection system 100, the image collection device 120 captures an image of the BOB. In the preferred embodiment depicted in FIG. 2, the control circuit 130 comprises an input terminal block 131 and a USB port 132. The reflective photo beam sensor is connected to the terminal block 131, which is in turn connected to both the USB port 132 and image collection device 120. The image collection device 120 can be, for example, a USB camera, which in the preferred embodiment is attached to both the terminal block 131 and USB port 132, but a person of skill in the art would understand that any standard image collection device could be utilized. Additionally, in certain embodiments, the control circuit 130 can be configured to provide an output for transmission of the captured image to the cashier or other employee responsible for checking BOB. The output can be accomplished with any suitable means of transmission, such as via USB, HDMI, VGA, or any number of other wired or wireless means of transmissions (e.g., bluetooth, wifi, etc.). In other embodiments, the image collection device 120 may handle both image collection, storage, and transmission

The image collection device 120 is mounted such that, when triggered, the captured image includes BOB and allows for visual verification as to whether or not items are present in BOB. Depending on how the BOB detection system 100 is installed, various mounting configurations are possible in order to make sure that the captured image includes BOB, as would be understood by a person of skill in the art. In the preferred embodiment illustrated in FIGS. 2 and 3, a USB camera is coupled to a reflective photo beam sensor so as to cause the USB camera to capture an image when the reflective photo beam sensor detects a reflective surface. In this specific example, it has been determined that spacing the reflective photo beam sensor 110 and image collection device 130 approximately 10-12 inches apart results in an image that consistently captures BOB without image blur or distortion. A person of skill in the art would understand that the use of alternative components or implementations might require or allow for different configurations to yield similar results. As demonstrated in FIGS. 2 and 3, the various components optionally can be packaged together in such a way that the BOB detection system 100 forms a single unit for easy install and/or retrofitting of existing equipment.

FIG. 4 is an exemplar of a potential cashier terminal screen according to the preferred embodiment of the invention. As depicted in FIG. 4, once an image is captured by image collection device 120, that image can be transmitted to the screen of the cashier effectuating checkout or some other employee responsible for verifying whether items are present in BOB. Together with that image, the cashier or other employee might be required to take affirmative action, such as pressing “y” (yes) or “n” (no), to indicate whether items are present in BOB. This can be accomplished utilizing standard software implementations and ensures that BOB can be checked consistently without requiring the customer or cashier to remember to check for items present in BOB separately. Therefore, the systems and methods described herein may be used to minimize losses through items in BOB that otherwise may not be detected.

This capability optionally could be combined with the ability to automatically or easily acknowledge the presence of certain items that commonly are stored in BOB, such that the cashier or other employee might directly indicate the presence of such items without having to separately scan or otherwise enter identification information for such items. For example, in addition to buttons marked “y” (yes) or “n” (no) to indicate whether items are present in BOB, as described in FIG. 4, standard software and/or hardware implementations could assign additional buttons to be used for certain commonly purchased items that customers tend to store in BOB, such as soft drinks, toilet paper, diapers, etc. While the use of additional buttons is specifically referenced, one skilled in the art will recognize that any commonly utilized method for data entry would suffice to allow the cashier or other employee to add such items to a customer's order without requiring the cashier or other employee to physically scan or otherwise enter identification information.

Additionally, as one skilled in the art will recognize with the benefit of this disclosure, a BOB detection and image capture system and methods for checking items in BOB can be configured with substitutes for or a subset of the components described herein. For example, reflective photo beam sensor 110 may be replaced with two or more separate sensors, provided that both emitter and receptor sensors are used and are configured so as to sense the presence of reflective material in the area in front of the BOB detection system 100. Additionally, the image captured by image collection device 120 can be transmitted to the employee responsible for verifying the presence of items in BOB by any number of wired or wireless means.

Therefore, the present invention is well adapted to attain the ends and advantages mentioned, as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

What is claimed is:

1. A method comprising:
emitting a photoelectric signal from a bottom of basket detection unit disposed at or in the vicinity of a checkout lane to an area at or in the vicinity of a checkout lane,
detecting a reflection of the photoelectric signal from a reflective surface disposed on a shopping cart passing through the area at or in the vicinity of the checkout lane,
in response to the detection of the reflected signal, capturing an image of a bottom of basket area of the shopping cart, and
transmitting the image to a display for verifying whether items are present in the bottom of basket area.

2. The method of claim 1, wherein the photoelectric signal is emitted from one sensor and the reflected signal is detected by a different sensor.

3. The method of claim 1, wherein the photoelectric signal is emitted from the same sensor and that detects the reflected signal.

4. The method of claim 1, wherein transmitting the image to a display is accomplished via a wired connection.

5. The method of claim 1, wherein transmitting the image to a display is accomplished via a wireless connection.

6. The method of claim 1, wherein transmitting the image to a display is accomplished by the same portion of the bottom of basket detection unit that captures the image of the bottom of basket area.

7. The method of claim 1, further comprising:
requiring verification as to whether items are present in the bottom of basket area before a customer transaction can be completed.

8. The method of claim 7, further comprising:
allowing the employee responsible for verifying whether items are present in the bottom of basket area to add items to a customer's order that are present in the bottom of basket area without having to physically touch or manipulate the items.

9. A bottom of basket detection system comprising:
a shopping cart having an area with a reflective surface;
a reflective photo beam sensor disposed at or in the vicinity of a checkout lane, the reflective photo beam sensor comprising:
a photoelectric signal emitter configured to emit a photoelectric beam that crosses a portion of an area at or in the vicinity of a checkout lane across which the reflective surface of the shopping cart would be expected to pass, and
a photoelectric signal receiver configured to receive a reflection of said photoelectric beam when a reflective surface is present in the path of the photoelectric beam;
an image collection device configured to capture an image of the bottom of basket area of the shopping cart when the reflective photo beam sensor indicates the presence of a reflective surface at or in the vicinity of a checkout lane; and
a display capable of displaying images captured by the image collection device.

10. The bottom of basket detection system of claim 9, wherein the photoelectric signal emitter and photoelectric signal receiver are at least two separate sensors.

11. The bottom of basket detection system of claim 9, wherein the photoelectric signal emitter and photoelectric signal receiver are contained within a single sensor.

12. The bottom of basket detection system of claim 9, wherein the image collection device is a USB camera.

13. The bottom of basket detection system of claim 9, wherein the space between the image collection device and the photoelectric signal receiver is approximately 10-12 inches.

14. The bottom of basket detection system of claim 9, wherein the reflective photo beam sensor and image collection device are housed within a single casing.

15. The bottom of basket detection system of claim 9, wherein the image collection device is a USB camera.

16. The bottom of basket detection system of claim 9, wherein the image collection device is capable of transmitting images directly to the display.

17. The bottom of basket detection system of claim 9, wherein the display includes means capable of allowing an employee to add to a customer's order items present in the bottom of basket area without having to physically touch or manipulate the items.

18. A bottom of basket detection system comprising:
a shopping cart having an area with a reflective surface;
a reflective photo beam sensor disposed at or in the vicinity of a checkout lane, the reflective photo beam sensor comprising:
a photoelectric signal emitter configured to emit a photoelectric beam that crosses a portion of an area at or in the vicinity of a checkout lane across which the reflective surface of the shopping cart would be expected to pass, and
a photoelectric signal receiver configured to receive a reflection of said photoelectric beam when a reflective surface is present in the path of the photoelectric beam;
an image collection device configured to capture an image of the bottom of basket area of the shopping cart when the reflective photo beam sensor indicates the presence of a reflective surface at or in the vicinity of a checkout lane;
a display capable of displaying images captured by the image collection device; and
a point of sale terminal disposed at or in the vicinity of the checkout lane.

19. The bottom of basket detection system of claim 18, wherein the display capable of displaying images captured by the image collection device is integrated with the point of sale terminal.

20. The bottom of basket detection system of claim 19, wherein the photoelectric signal emitter and photoelectric signal receiver are at least two separate sensors.

21. The bottom of basket detection system of claim 19, wherein the photoelectric signal emitter and photoelectric signal receiver are contained within a single sensor.

22. The bottom of basket detection system of claim 19, wherein the image collection device is a USB camera.

23. The bottom of basket detection system of claim 19, wherein the space between the image collection device and the photoelectric signal receiver is approximately 10-12 inches.

24. The bottom of basket detection system of claim 19, wherein the reflective photo beam sensor and image collection device are housed within a single casing.

25. The bottom of basket detection system of claim 19, wherein the image collection device is a USB camera.

26. The bottom of basket detection system of claim 19, wherein the image collection device is capable of transmitting images directly to the display.

27. The bottom of basket detection system of claim 19, wherein the display includes means capable of allowing an employee to add to a customer's order items present in the bottom of basket area without having to physically touch or manipulate the items.

28. The bottom of basket detection system of claim 19, wherein the point of sale terminal includes means capable of allowing an employee to add to a customer's order items present in the bottom of basket area without having to physically touch or manipulate the items.

29. The bottom of basket detection system of claim 18, wherein the display capable of displaying images captured by the image collection device is separate from the point of sale terminal.

30. The bottom of basket detection system of claim 29, wherein the photoelectric signal emitter and photoelectric signal receiver are at least two separate sensors.

31. The bottom of basket detection system of claim 29, wherein the photoelectric signal emitter and photoelectric signal receiver are contained within a single sensor.

32. The bottom of basket detection system of claim 29, wherein the image collection device is a USB camera.

33. The bottom of basket detection system of claim 29, wherein the space between the image collection device and the photoelectric signal receiver is approximately 10-12 inches.

34. The bottom of basket detection system of claim 29, wherein the reflective photo beam sensor and image collection device are housed within a single casing.

35. The bottom of basket detection system of claim 29, wherein the image collection device is a USB camera.

36. The bottom of basket detection system of claim 29, wherein the image collection device is capable of transmitting images directly to the display.

37. The bottom of basket detection system of claim 29, wherein the display includes means capable of allowing an employee to add to a customer's order items present in the bottom of basket area without having to physically touch or manipulate the items.

38. The bottom of basket detection system of claim 29, wherein the point of sale terminal includes means capable of allowing an employee to add to a customer's order items present in the bottom of basket area without having to physically touch or manipulate the items.
